(19) United States
(12) Patent Application Publication
(10) Pub. No.: US 2006/0105308 A1
(43) Pub. Date: May 18, 2006

(54) Rosary keepsake Urn

(76) Inventor: Susan Claire Fraser, Three Rivers, CA (US)

Correspondence Address: Susan Fraser, 40984 Grouse Dr., Three Rivers, CA, 93271, US

(21) Appl. No.: 11/273,759

(22) Filed: Nov. 14, 2005

Related U.S. Application Data
(60) Provisional application No. 60/628,719, filed on Nov. 16, 2004.

(51) Int. Cl. A44C 23/00; G09B 19/00

(52) U.S. Cl. 434/246

(57) ABSTRACT

The Rosary Keepsake Urn holds cremains, hair, or fur of any person living or dead, pet or animal. A rosary is attached to the cross. This consists of any length of any type of beads, chains, cords, wires, string or other material, considered a rosary. People of the Catholic faith feel connected to the rosary with their loved ones cremains, hair or fur inside. Some keep the rosary as a life long keepsake, while others hold the rosary during services or the brief grieving time prior to burial. They then bury or inter the rosary with the rest of the deceased cremains, as the Catholic religion requires. Some people put their deceased pet's cremains or fur in the cross, as a keepsake to their animal.

### CROSS REFERENCE FOR PRIOR APPLICATION

This application claims priority to provisional 60/628,719 filed on Nov. 16, 2004.

### FEDERAL FUNDING

N/A

### BACKGROUND OF THE INVENTION

Crosses which hold cremains, and rosaries used for prayer have been sold separately. They have not been put together and sold as I have here, a Rosary Keepsake Urn.

### BRIEF DESCRIPTION

I have combined the concepts of the rosary and crosses holding cremains, to make this total item, a Rosary Keepsake Urn which holds cremains, hair, crushed flowers or fur, as keepsake, in memory of a person, pet or animal. This is the main purpose of the Rosary Keepsake Urn.

### BRIEF DESCRIPTION OF DRAWING

FIG. 1 is representative of the rosary and FIG. 2 is representative of the cross.

### DETAILED DESCRIPTION

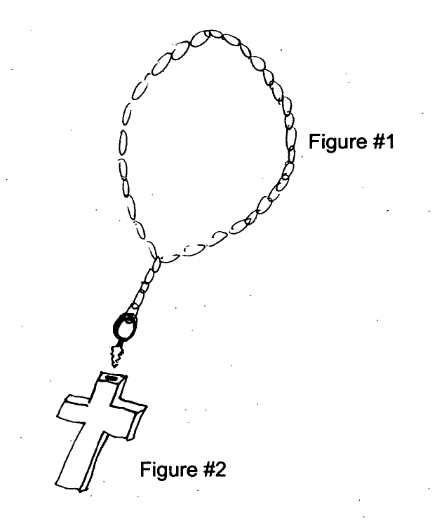

This product is now being offered to the public as a cremation keepsake, called a Rosary Keepsake Urn. A cross (FIG. 2) with a screw top opening, holds cremains, hair, or fur of any person living or dead, or any pet or animal. A rosary (FIG. 1) is attached to the cross. This consists of any length of any type of beads, chains, cords, wires, string or other material, considered a rosary.

People of the Catholic faith feel connected to the rosary with their loved ones cremains, hair or fur inside. Some keep the rosary as a life long keepsake, while others hold the rosary during services or the brief grieving time prior to burial. They then bury or inter the rosary with the rest of the deceased cremains, as the Catholic religion requires. Some people put their deceased pet's cremains or fur in the cross, as a keepsake to their animal.

The cremains, hair or fur can be added with the aid of a toothpick and a funnel (which is included) to the interior of the cross. The screw opening of the cross is then closed, adhesive, which is also included, is used to seal the opening at the screw. The top of the cross has an attached ring of metal, such as a jeweler's ring, which is attached to any length of any type of beads, chains, cords, wires, string or other material, which is considered a rosary.

The Rosary Keepsake Urn's main feature is the fact that the cross holds cremains, hair, crushed flowers or fur, as keepsake, in memory of a person, pet or animal. This is the main purpose of the Rosary Keepsake Urn.

1. A rosary is attached to a cross which holds cremains, crushed flowers, hair or fur.

2. A rosary consisting of any length, any type of bead, chain, cord, wire, string or other material, considered a rosary, is attached to the cross. The cross is made of any material, has a hollow interior to hold the cremains, hair, crushed flowers or fur and has a screw on top, to keep the cremains secure.

3. The cross has a screw opening and cremains or cremated ash or hair of any person living or dead or cremains or fur of an animal and or pet, living or dead, are added. They can be added with the aid of a toothpick and a funnel (which are included) to the interior of the cross. The screw opening of the cross is then closed, adhesive, which is also included, is used to seal the opening at the screw. The top of the cross has an attached ring of metal, such as a jeweler's ring, which is attached to any length of any type of beads, chains, cords, wires, string or other material, which is considered a rosary.
A rosary is a Catholic religion piece for praying. People who have lost a person, pet or animal can place cremains, hair, crushed flowers or fur in the cross. The rosary can be interred or buried with the remainder of the cremains of the person or pet or can be kept as a keepsake.
The Rosary Keepsake Urn's main feature is the fact that the cross holds cremains, hair or fur, as keepsake in memory of a person or pet, alive or dead. This is the main purpose of the Rosary Keepsake Urn.
